(19) United States
(12) Patent Application Publication
(10) Pub. No.: US 2018/0138773 A1
(43) Pub. Date: May 17, 2018

(54) ROTOR

(71) Applicant: MABUCHI MOTOR CO., LTD., Matsudo City (JP)

(72) Inventor: Yasuhiro YAMAGATA, Matsudo City (JP)

(73) Assignee: MABUCHI MOTOR CO., LTD., Matsudo City (JP)

(21) Appl. No.: 15/794,793

(22) Filed: Oct. 26, 2017

(30) Foreign Application Priority Data
Nov. 15, 2016 (JP) 2016-222109

(51) Int. Cl. H02K 3/52; H02K 1/24; H02K 3/18; H02K 1/28

(52) U.S. Cl. CPC H02K 3/527; H02K 1/28; H02K 3/18; H02K 1/24

(57) ABSTRACT

A rotor having a core with a novel configuration, where the rotor is provided with a first component having a plurality of teeth radially disposed about a rotating axis, a coil wound on the plurality of teeth, and a tubular second component fixed to the first component so as to connect distal ends of the plurality of teeth. The first component and the second component constitute a core. The second component has a multilayer structure of a plurality of laminated steel sheets.

### BACKGROUND

### 1. Technical Field

The present invention relates to a rotor.

### 2. Description of the Related Art

The rotor of a typical direct-current motor has coils wound on the teeth of a core including a lamination of a plurality of steel sheets. The core has slots on an outer peripheral surface for winding the coils on the teeth. The rotor has room for improvement with respect to cogging and rotational stability.

A technology has been devised to overcome the problem of cogging, rotational stability and the like by providing a so-called slot-less rotor in which the slots are not exposed on the outer peripheral surface (see JP-UM-B-5-1964). Specifically, the rotor is constructed by press-fitting the distal ends of the teeth having the coils wound thereon into engaging recessed portions on the inner peripheral surface of a cylinder-shaped member made from an iron-based sintered alloy or a magnetic powder-containing resin material.

### SUMMARY

The cylinder-shaped member is fabricated by casting where it is not easy to achieve high dimensional accuracy or complex shapes. Accordingly, in order to achieve miniaturization and performance improvement of a motor by realizing an optimum magnetic circuit including the rotor and magnets, a further effort is required with respect to the core configuration.

The present invention has been made in view of the above circumstances, and an object of the present invention is to provide a rotor which includes a core with a novel configuration.

In order to solve the problem, according to an aspect of the present invention, there is provided a rotor including: a first component including a plurality of teeth radially disposed about a rotating axis; a coil wound on the plurality of teeth; and a tubular second component fixed to the first component so as to connect respective distal ends of the plurality of teeth. The first component and the second component constitute a core, and the second component has a multilayer structure of a plurality of laminated steel sheets.

According to the above aspect, the first component can be fixed to the second component after the coil is wound on the teeth, so that the coil can be more densely wound on the teeth. Because the second component is fixed to the first component so as to connect the distal ends of the plurality of teeth, sticking-out of the coils due to rotation of the rotor can be reduced. The method for winding the coil on the teeth may include so-called concentrated winding and lap winding.

The teeth may include a mating portion at the distal end, and the second component may include a mated portion provided in a tubular inner peripheral portion thereof for fixing the mating portion. In this way, the first component and the second component can be accurately connected to each other. The mating portion may be a projecting portion, and the mated portion may be a recessed portion. Alternatively, the mating portion may be a recessed portion, and the mated portion may be a projecting portion.

The second component may include fixing portions provided at symmetric positions across the mating portion for fixing the laminated steel sheets together. In this way, when the mating portion of the first component is fixed to the mated portion of the second component, uneven deformation of the outer periphery of the core due to fixing stress can be suppressed.

The second component may include a slot-less layer with a continuous circumference, and a slotted layer with a partly discontinuous circumference. In this way, the sticking-out of the coils can be reduced while the occurrence of cogging is suppressed.

The slot-less layer may be configured from an annular first steel sheet with a continuous circumference, and the slotted layer may be configured from one or more arc-shaped second steel sheets with a discontinuous circumference. In this way, the core including a layer formed with a slot and a layer formed without a slot can be fabricated by simply laminating a plurality of kinds of steel sheets as tubular members. As a result, a core with a desired shape can be fabricated more simply than by a method whereby a cylindrical core is formed by laminating only annular steel sheets with a continuous circumference, and then processing a portion corresponding to the slot.

The second component may satisfy 0<n2/(n1+n2)<1 where n1 is the total thickness of the slot-less layers, and n2 is the total thickness of the slotted layers. Preferably, the second component may satisfy 0.2<n2/(n1+n2)<0.95. More preferably, the second component may satisfy 0.4<n2/(n1+n2)<0.89. In this way, a decrease in the amount of magnetic flux due to magnetic shorting can be suppressed while reducing cogging.

The slot-less layer may include a thin portion which is, in a direction of the rotating axis, adjacent to a slot formed in the slotted layer. The slot-less layer may satisfy 0.2×t1<t2<5.0×t1 where t1 is the thickness of a single steel sheet, and t2 is the thickness in a radial direction of the thin portion. Preferably, the slot-less layer may satisfy 0.5×t1≤t2≤3.0×t1. In this way, a slot-less layer can be obtained in which motor characteristics and steel sheet productivity (workability) are taken into consideration.

The relationship 0<L<0.3×n3 may be satisfied, where L is the height in a direction of the rotating axis of a slot formed in the slotted layer, and n3 is a total thickness of the core. In this way, sticking-out of the coils can be reduced. Preferably, the relationship 0<L<0.2×n3 may be satisfied. In this way, sticking-out of the coils can be further reduced. More preferably, the relationship 0<L<0.1×n3 may be satisfied. In this way, sticking-out of the coils can be reduced even more.

The second component may include a slotted layer with a partly discontinuous circumference. The slotted layer may include a first slotted layer configured from an arc-shaped steel sheet and having a first slot, and a second slotted layer adjacent to the first slotted layer and configured from an arc-shaped steel sheet, the second slotted layer having a second slot at a position different from the position of the first slot circumferentially. In this way, a plurality of slots with different circumferential positions can be formed without using a steel sheet having a different shape.

According to another aspect of the present invention, there is provided a motor. The motor is provided with a tubular housing; a stator disposed along an inner surface of the housing and having a pair of more of magnetic poles; a rotor disposed so as to oppose the stator; and a plurality of brushes disposed so as to slide on an outer peripheral surface of a commutator.

The above-described constituent elements may be combined as desired, or the expression of the present invention may be transformed between a method, a device, a system and the like, and such embodiments may also provide valid embodiments of the present invention.

According to the present invention, a rotor having a core with a novel configuration can be provided.

### BRIEF DESCRIPTION OF THE DRAWINGS

FIG. 1 is a front view of a DC motor according to a first embodiment;

FIG. 2 is a cross sectional view of the DC motor according to the first embodiment;

FIG. 3A is a top view of a first component corresponding to the teeth of a core;

FIG. 3B is a side view of the first component;

FIG. 4 is a perspective view of the first component with a shaft inserted at the center thereof;

FIG. 5A is a top view of a second component corresponding to a tubular portion of the core;

FIG. 5B is a side view of the second component;

FIG. 6A is a perspective view of an insulator;

FIG. 6B is a perspective view of the insulator with a coil wound thereon;

FIG. 7A is a top view of a rotor according to the first embodiment;

FIG. 7B is a side view of the rotor according to the first embodiment;

FIG. 8 is a top view of the first component and the second component press-fitted into each other;

FIG. 9A is a top view of an electromagnetic steel sheet that constitutes a slot-less layer of a core according to a second embodiment;

FIG. 9B is a top view of an electromagnetic steel sheet that constitutes a slotted layer of the core according to the second embodiment;

FIG. 9C is a perspective view of a basic unit of the second component that constitutes the core according to the second embodiment;

FIG. 10 is a side view of the second component according to the second embodiment;

FIG. 11 is a top view of an electromagnetic steel sheet that constitutes the second component according to a third embodiment;

FIG. 12 is a side view of the second component according to the third embodiment; and

FIG. 13 is a top view of the core according to a fourth embodiment.

### DESCRIPTION OF THE EMBODIMENTS

In the following, embodiments of the present invention will be described with reference to the drawings. Like references refer to like elements, and overlapping descriptions will be omitted as appropriate. The configurations described below are merely examples and not intended to be limiting of the scope of the present invention.

### First Embodiment

### (DC Motor)

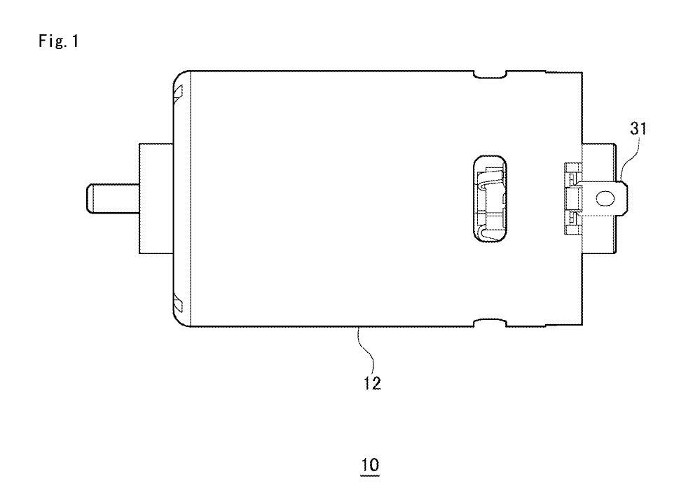

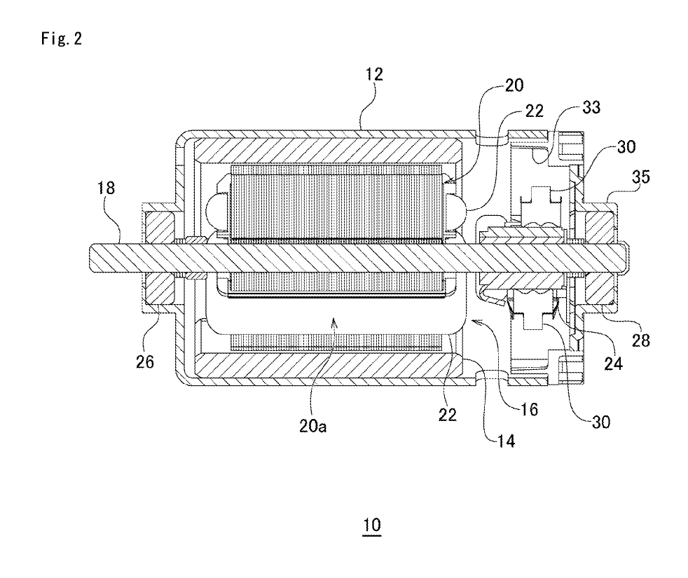

FIG. 1 is a front view of a DC motor according to the first embodiment. FIG. 2 is a cross sectional view of the DC motor according to the first embodiment. The DC motor 10 is a 2-pole, 3-slot motor in which one or a plurality of magnets 14 is disposed on the inner wall of a cylindrical housing 12. The magnets 14 are disposed in such a way that the magnetic poles (N-pole and S-pole) are positioned on the inside, the N-pole and S-pole being alternately arranged in the circumferential direction of the inner wall of the housing 12. A stator is mostly constructed of the housing 12 and the magnets 14.

In a central portion of the housing 12, a rotor 16 is disposed. The rotor 16 is provided with a shaft 18, a core 20, coils 22, and a commutator 24. The shaft 18 is a rotating shaft which supports the rotor 16 via bearings 26, 28. The shaft 18 also functions as an output shaft. The core 20 of the rotor 16 is disposed opposite the magnets 14.

The core 20 includes a lamination of a plurality of electromagnetic steel sheets with the shaft 18 fixed at the center thereof in a penetrating state. The coils 22 are wound in grooves 20a of the core 20, and produce magnetic force by having a flow of electric current passed through the coils 22.

The commutator 24 is fixed to the shaft 18, as is the core 20. The commutator 24 includes contacts to which an electric current is supplied via brushes 30 that slidably contact the outer peripheral surface of the contacts. The contacts are used to allow the electric current to flow through the coils 22 at appropriate timing. The brushes 30 are carbon brushes mainly composed of carbon, for example. In some cases, the brushes may be forked metal brushes mainly composed of precious metal and the like.

The brushes 30 are connected to brush bases 31 including terminals and fixed to a brush holder 33. The brush holder 33 is installed in the housing 12. The housing 12 has an opening which is covered with an end-bell 35.

### (Core)

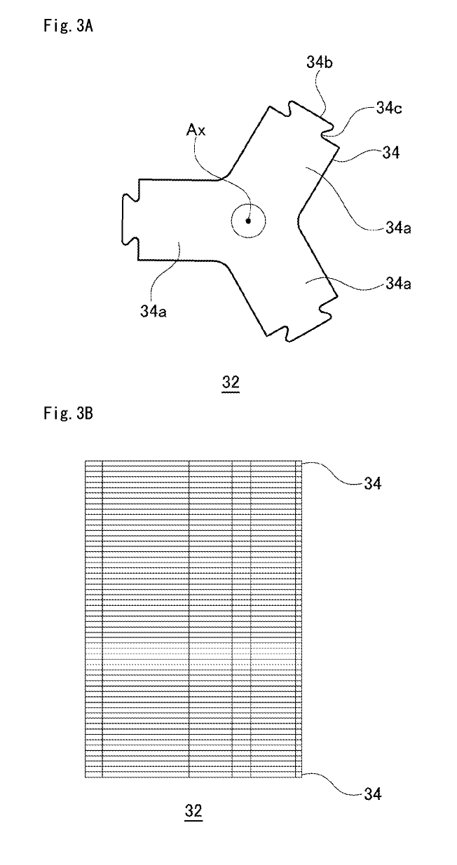

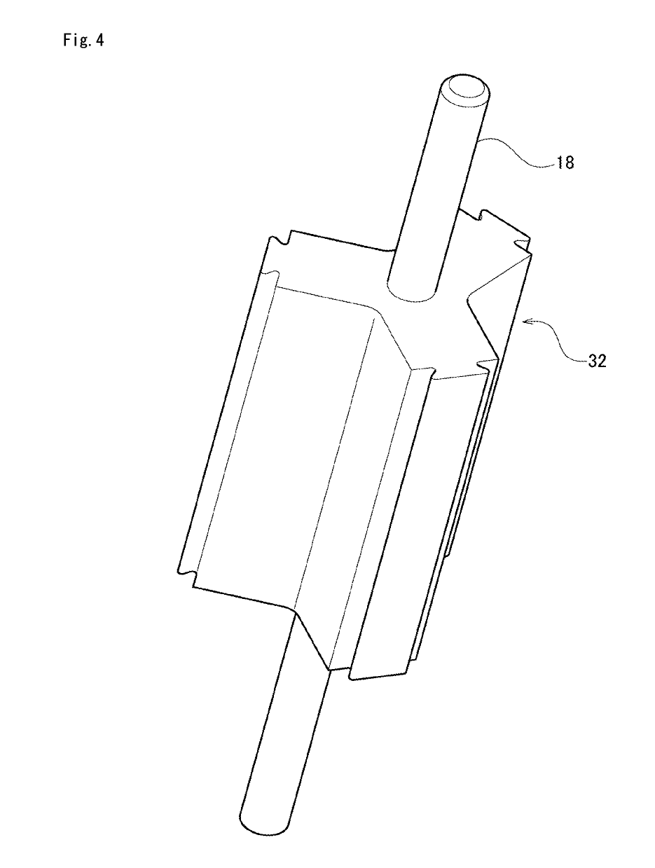

The core 20 according to the present embodiment is constructed by combining a plurality of components. FIG. 3A is a top view of a first component 32 corresponding to the teeth of the core 20. FIG. 3B is a side view of the first component 32. FIG. 4 is a perspective view of the first component 32 with the shaft 18 inserted at the center.

The first component 32, as illustrated in FIG. 3B, includes a lamination of identically shaped electromagnetic steel sheets 34. The electromagnetic steel sheets are fixed to one another by, e.g., laser welding, a boss-staking method, or mating by being press-fit into the shaft 18. The electromagnetic steel sheets 34, as illustrated in FIG. 3A, include a plurality of teeth 34a radially disposed about a rotating axis Ax. The teeth 34a are each provided with a projecting portion 34b at a distal end. The projecting portion 34b includes a base portion 34c that has a smaller width than the distal end.

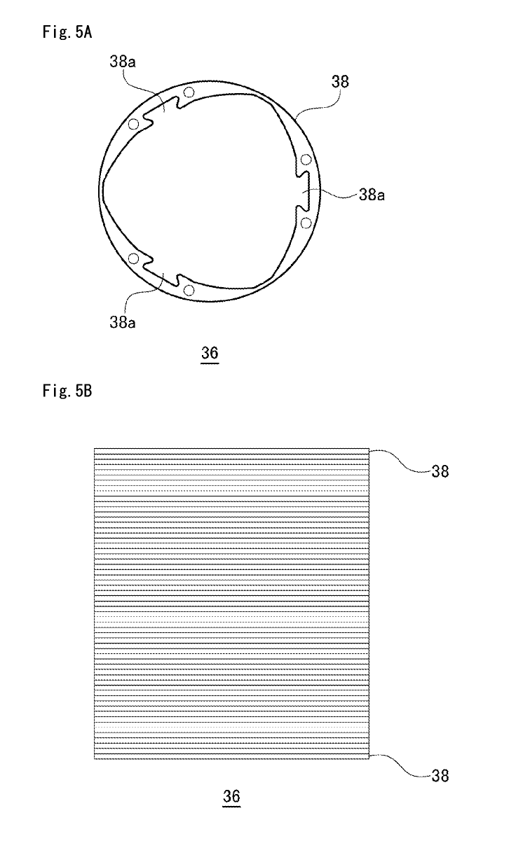

FIG. 5A is a top view of a second component 36 corresponding to the tubular portion of the core 20. FIG. 5B is a side view of the second component 36.

The second component 36, as illustrated in FIG. 5B, has a multilayer structure including a lamination of identically shaped electromagnetic steel sheets 38. The electromagnetic steel sheets are fixed to one another by, e.g., laser welding or mating by a boss-staking method. The electromagnetic steel sheets 38, as illustrated in FIG. 5A, are annular components. The electromagnetic steel sheets 38 have three recessed portions 38a at inner peripheral portions thereof that are provided at equal intervals circumferentially for press-fitting the projecting portions 34b of the first component 32.

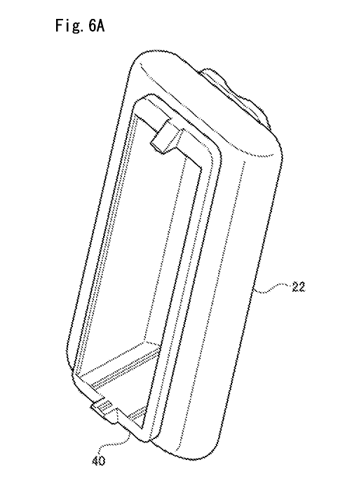

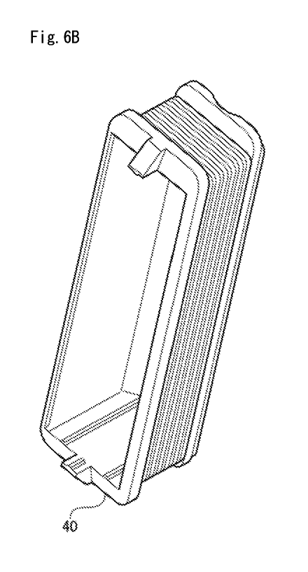

A method for manufacturing the rotor will be described. Initially, the first component 32 illustrated in FIG. 4 is prepared. Then, the coils 22 are mounted on the respective teeth 34a of the first component 32. According to the present embodiment, the coils are wound on a tubular insulator before installment. FIG. 6A is a perspective view of the insulator 40. FIG. 6B is a perspective view illustrating a state in which the coil 22 is wound on the insulator 40.

The insulator 40 with the coil 22 wound thereon as illustrated in FIG. 6B is mounted on each of the teeth 34a of the first component 32 illustrated in FIG. 3. In this state, the second component 36 is press-fit on the first component 32 along the rotating axis. In this way, the first component 32 is fixed to the second component 36 after the coils 22 are wound (mounted) on the teeth 34a. Accordingly, the coils 22 can be more densely wound on the teeth 34a. In addition, because the second component 36 is fixed to the first component 32 in such a way that the respective distal ends of the plurality of teeth 34a are connected, sticking-out of the coils 22 due to the rotation of the rotor 16 can be prevented.

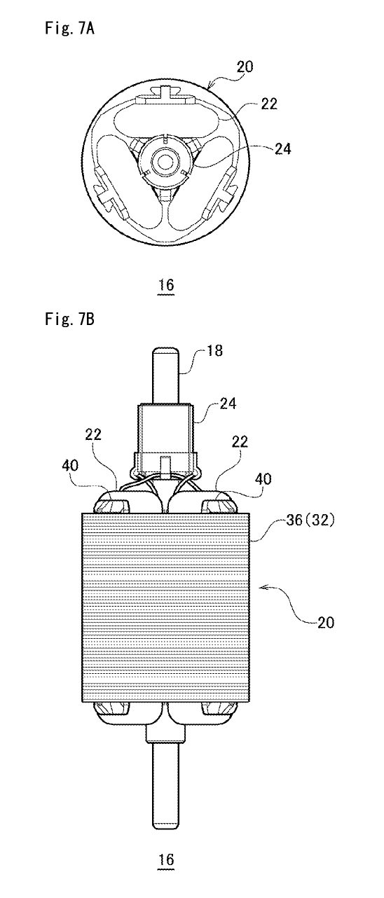

FIG. 7A is a top view of the rotor 16 according to the first embodiment. FIG. 7B is a side view of the rotor 16 according to the first embodiment. The rotor 16 according to the first embodiment is provided with: the first component 32; the second component 36; the coils 22 wound on each of the plurality of teeth 34a of the first component 32; and the commutator 24 fixed to the shaft 18.

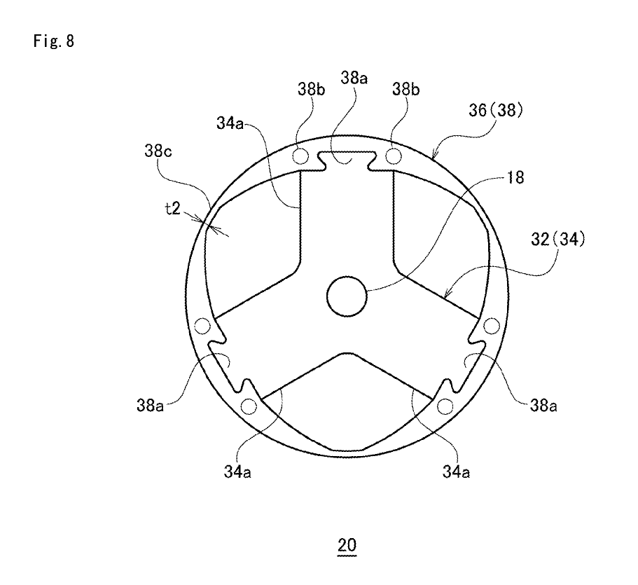

FIG. 8 is a top view illustrating the state in which the first component 32 and the second component 36 are press-fitted into each other. While the actual DC motor 10 has the coils 22 wound on the teeth 34a of the first component 32, illustration of the coils 22 is omitted in FIG. 8.

As illustrated in FIG. 8, the tubular second component 36 is fixed to the first component 32 by press-fitting such that the distal ends of the plurality of teeth 34a are connected. In this way, the first component 32 and the second component 36 are accurately and strongly connected.

The second component 36 includes fixing portions 38b for fixing the steel sheets to one another which are disposed at symmetric positions across the recessed portions 38a. The fixing portions 38b may be configured for mating by staking of bosses, for example. In this way, when the projecting portions 34b of the first component 32 are press-fit in the recessed portions 38a of the second component 36, uneven deformation of the outer periphery of the core due to strain can be suppressed. As a result, cogging of the motor in use can be suppressed, and stable and smooth rotation can be achieved.

The electromagnetic steel sheets 38 of the second component 36 according to the present embodiment are such that the core as a whole is constructed of slot-less layers that have no outer peripheral slots (i.e., the periphery is continuous). The slot-less layers include thin portions 38c between the recessed portions 38a of the electromagnetic steel sheets 38. The electromagnetic steel sheets 38 according to the present embodiment satisfy 0.2×t1≤t2≤5.0×t1, where t1 is the thickness of a single electromagnetic steel sheet 38, and t2 is the thickness of the thin portions 38c in the radial direction. Preferably, the electromagnetic steel sheets 38 may satisfy 0.5×t1≤t2≤3.0×t1. In this way, the slot-less layers can be obtained in which the motor characteristics and the steel sheet productivity (workability) are taken into consideration.

The thickness of the electromagnetic steel sheets 38 may not be the same throughout the slot-less layers, and some of the electromagnetic steel sheets 38 may have different thicknesses. When a plurality of types of electromagnetic steel sheets with varying thicknesses is laminated, the radial thickness t2 of the thin portion may satisfy 0.2×t1′≤t2≤5.0×t1′, where t1′ is the thickness of the electromagnetic steel sheet having the greatest thickness. More preferably, the radial thickness t2 may satisfy 0.5×t1′≤t2≤3.0×t1′.

### Second Embodiment

The core 20 according to the first embodiment is a cylindrical member without peripheral slots. Accordingly, the structure is very effective in preventing the sticking-out of the coils or reducing cogging. However, because the distal ends of the teeth are connected, a decrease in effective magnetic flux may be caused by magnetic shorting between the teeth.

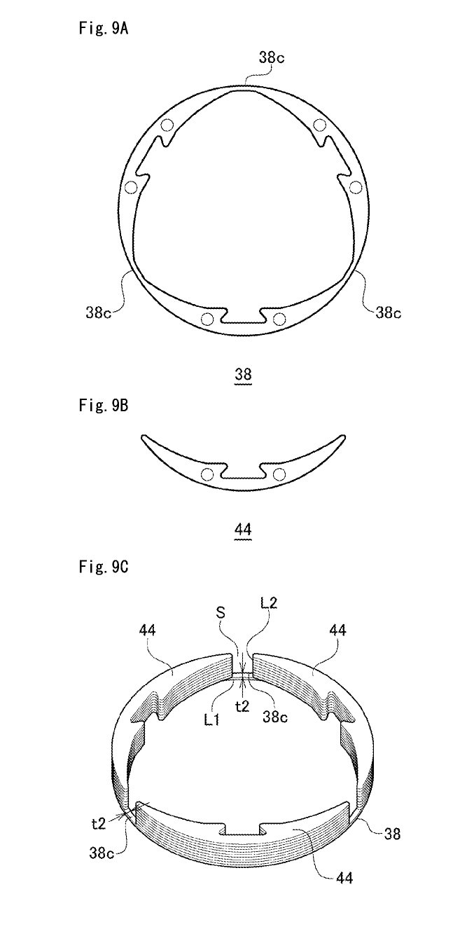

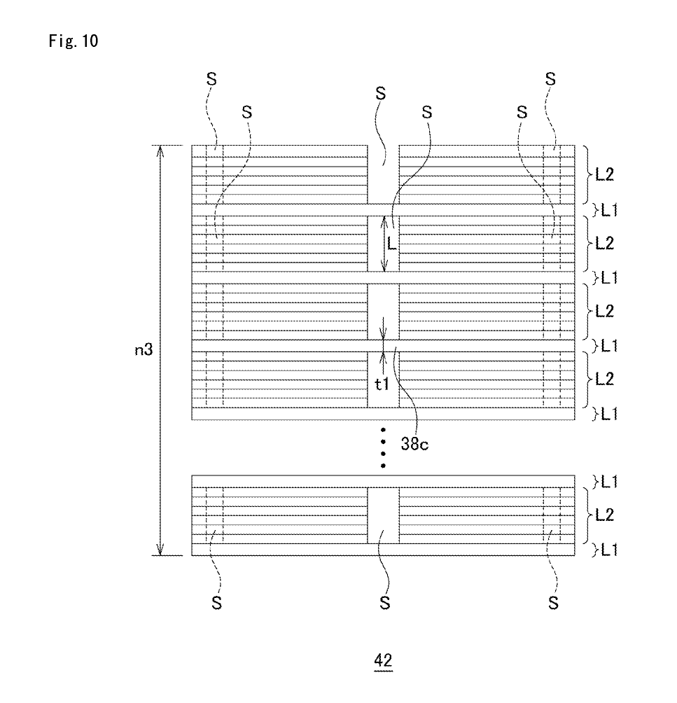

Accordingly, the core according to the second embodiment has a configuration in which slot-less layers and slotted layers are both present. FIG. 9A is a top view of an electromagnetic steel sheet 38 constituting a slot-less layer of the core according to the second embodiment. FIG. 9B is a top view of an electromagnetic steel sheet 44 constituting a slotted layer of the core according to the second embodiment. FIG. 9C is a perspective view of a basic unit of the second component constituting the core according to the second embodiment. FIG. 10 is a side view of the second component according to the second embodiment.

The second component 42 according to the second embodiment, as illustrated in FIG. 10, includes the slot-less layers L1 of which the circumference is continuous, and the slotted layers L2 of which the circumference is at least partly discontinuous. The second component 42 has the slot-less layers L1 and the slotted layers L2 that are alternately laminated. The presence of the slot-less layers L1 in parts of the second component 42 makes it possible to reduce the sticking-out of the coils while suppressing the occurrence of cogging.

The slot-less layers L1, as illustrated in FIG. 9A, are configured from the annular electromagnetic steel sheets 38 with a continuous circumference. The electromagnetic steel sheets 38 have the configuration as described with reference to the first embodiment. The slotted layers L2 are configured from the arc-shaped electromagnetic steel sheets 44 with a discontinuous circumference. In the slotted layers L2 according to the present embodiment, each layer is configured from three electromagnetic steel sheets 44. The electromagnetic steel sheets 44 have the shape of the electromagnetic steel sheets 38 from which the thin portions 38c have been eliminated to create three equally divided parts.

In this way, the core that includes the slotted layers L2 formed with slots S and the slot-less layers L1 not formed with the slots S can be fabricated by simply laminating a plurality of kinds of steel sheets as tubular members. As a result, the core with a desired shape can be fabricated more simply than by a method where, for example, a cylindrical core is formed by laminating only the annular steel sheets with a continuous circumference, and then the portions corresponding to the slots are processed.

The second component 42 satisfy 0<n2/(n1+n2)<1 where n1 is the total thickness of the slot-less layers L1, and n2 is the total thickness of the slotted layers L2. Preferably, the second component 42 may satisfy 0.2<n2/(n1+n2)<0.95. More preferably, the second component 42 may satisfy 0.4<n2/(n1+n2)<0.89. In this way, it becomes possible to suppress a decrease in the amount of magnetic flux due to magnetic shorting while reducing cogging. The total thickness of the slot-less layers L1 means the thickness dimension obtained by adding up all of the thicknesses when there is a plurality of slot-less layers L1. The total thickness of the slotted layers L2 means the thickness dimension obtained by adding up all of the thicknesses when there is a plurality of slotted layers L2.

The slot-less layers L1 include the thin portions 38c adjacent in the rotating axis direction to the slots S formed in the slotted layers L2, and satisfy 0.2×t1≤t2≤5.0×t1 where t1 is the thickness of a single electromagnetic steel sheet 38, and t2 is the thickness of the thickness of the thin portions 38c in the radial direction. Preferably, the slot-less layers L1 may satisfy 0.5×t1≤t2≤3.0×t1.

The second component 42 may satisfy 0<L<0.3×n3 where L is the height in the rotating axis direction of each slot S formed in the slotted layers L2, and n3 is the total thickness of the core. Preferably, the second component 42 may satisfy 0<L<0.2×n3. More preferably, the second component 42 may satisfy 0<L<0.1×n3. In this way, the sticking-out of the coils can be more reliably prevented.

### Third Embodiment

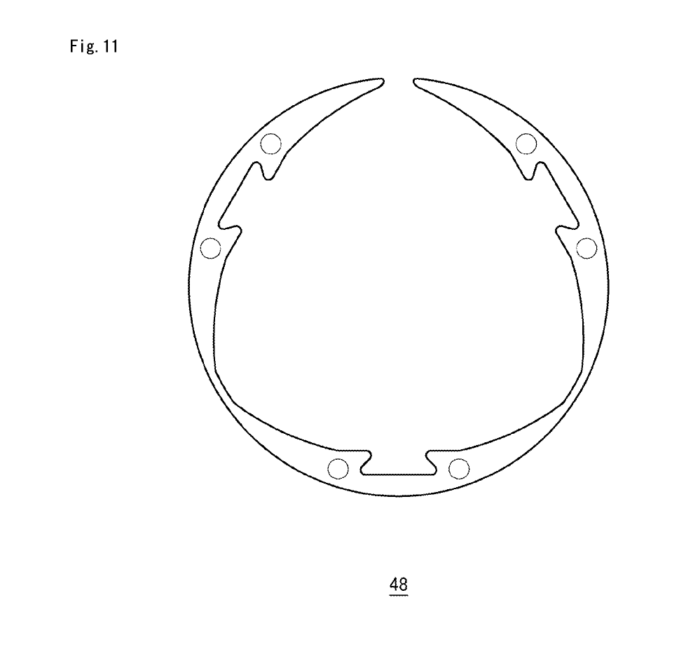

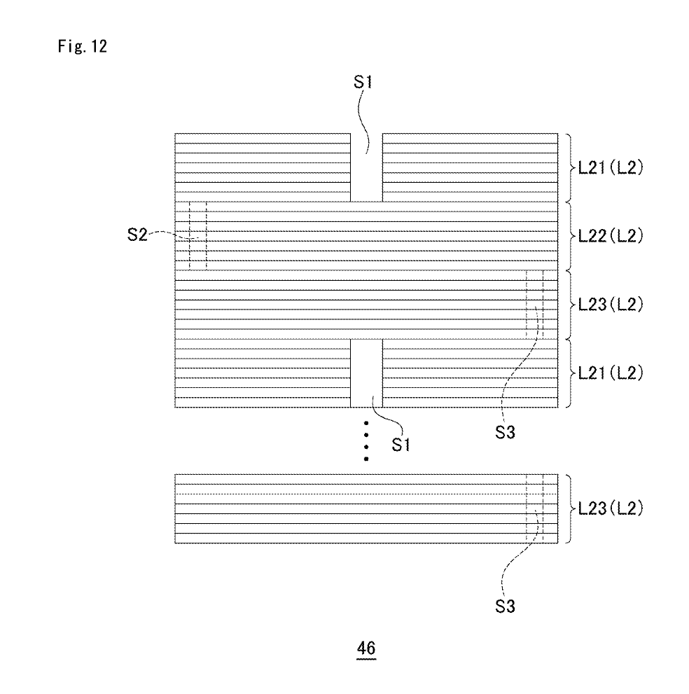

FIG. 11 is a top view of an electromagnetic steel sheet 48 constituting the second component according to the third embodiment. FIG. 12 is a side view of the second component 46 according to the third embodiment.

The second component 46 according to the third embodiment, as illustrated in FIG. 12, includes slotted layers L2 of which the circumference is partly discontinuous. In other words, the second component 46 does not include the slot-less layer. The slotted layers L2 include first slotted layers L21 which are configured from the arc-shaped electromagnetic steel sheets 48 as illustrated in FIG. 11, and which include a first slot S1; second slotted layers L22 adjacent to the first slotted layers L21 and configured from the arc-shaped electromagnetic steel sheets 48, the second slotted layers L22 including a second slot S2 at a circumferential position different from the position of the first slot S1; and third slotted layers L23 adjacent to the second slotted layers L22 and configured from the arc-shaped electromagnetic steel sheets 48, the third slotted layers L23 having a third slot S3 at a circumferential position different from the position of the second slot S2. In this way, it is possible to form a plurality of slots S1 to S3 having different circumferential positions without using steel sheets with different shapes. In addition, because all of the layers have slots, a decrease in the amount of magnetic flux is suppressed.

### Fourth Embodiment

Some uses may require high-speed rotation as motor performance. For example, under use conditions of 30,000 to 40,000 rpm or above, the rotor, particularly the ring core, may become deformed during rotation due to strong centrifugal force acting on the rotor. Accordingly, the present inventor has devised a core with a novel configuration with which the deformation during high-speed rotation can be suppressed more than with the cores according to the foregoing embodiments. Descriptions of configurations similar to those of the embodiments are omitted, as appropriate.

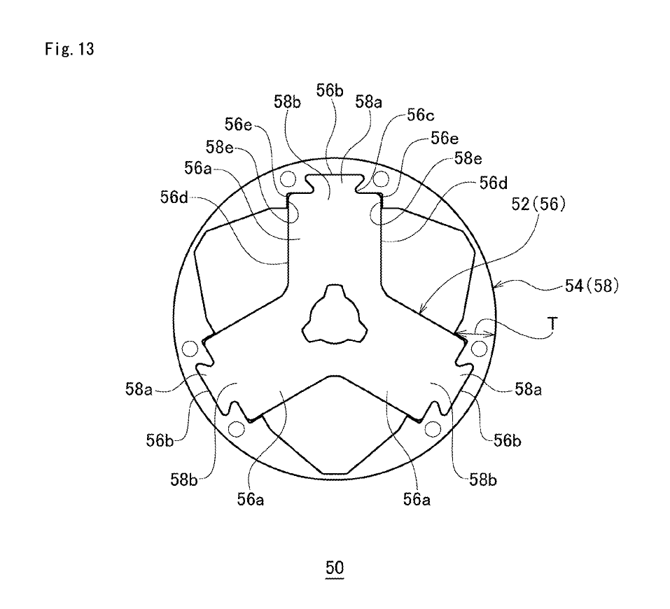

FIG. 13 is a top view of the core according to the fourth embodiment. The core 50 according to the present embodiment includes a first component 52 corresponding to the teeth, and a second component 54 corresponding to the tubular portion. The first component 52 and the second component 54 are mated and fixed to each other. The first component 52 includes a lamination of identically shaped electromagnetic steel sheets 56, and has a configuration substantially similar to that of the first component 32. The electromagnetic steel sheets 56, as illustrated in FIG. 13, include a plurality of teeth 56a radially disposed about a rotating axis. The teeth 56a each have a projecting portion 56b at the distal end. The projecting portion 56b has a base portion 56c with a width smaller than the distal end.

The second component 54 has a multilayer structure including a lamination of identically shaped electromagnetic steel sheets 58. The electromagnetic steel sheets are fixed to one another by mating by, e.g., laser welding or a boss-staking method. The electromagnetic steel sheets 58 are annular components, as illustrated in FIG. 13. The electromagnetic steel sheets 58 have three first recessed portions 58a provided in inner peripheral portions thereof at equal intervals circumferentially for press-fitting projecting portions 52b of the first component 52.

On the central side of the electromagnetic steel sheets 58 with respect to the first recessed portions 58a, second recessed portions 58b are formed with a circumferential width greater than that of the first recessed portions 58a. The second recessed portions 58b have a shape that holds a part of side surfaces 56d of the teeth 56a from both sides. In the second component 54 according to the present embodiment, step portions 56e in the vicinity of the base portion 56c of the teeth 56a are engaged with inner surfaces 58e of the second recessed portions 58b.

Thus, in the second component 54, the first recessed portions 58a are formed in the bottom of the second recessed portions 58b, resulting in a greater depth of the recessed portions as a whole compared with the second component 36 described above. Accordingly, a radial thickness T can be increased particularly in the areas adjacent to the second recessed portions 58b, whereby the strength of the second component 54 per se is increased. Further, the second component 54 not only has the projecting portions 56b of the teeth 56a being press-fit in the first recessed portions 58a, but also has the step portions 56e being press-fit in the second recessed portions 58b. Thus, the second component 54 is mated with the first component 52 via a greater number of surfaces, resulting in stronger coupling with the first component 52. As a result, even when the rotor is rotated at high speed, deformation of the rotor per se can be suppressed.

In this way, the problem of the outer peripheral portion of the rotor (outer peripheral portion of the second component 54) coming into contact with the stator-side magnets due to deformation can be avoided, and the occurrence of noise and a decrease in motor rotation efficiency can be prevented. In addition, the gap between the rotor and the stator can be made narrower by taking into consideration the component tolerance or assembly tolerance, whereby an increase in motor rotation efficiency can be achieved.

The present invention has been described with reference to the embodiments. The present invention, however, is not limited to the embodiments and may include combinations or substitutions of the configurations of the embodiments, as appropriate. It may be also possible to vary, as appropriate, the order of assembly or processing in the embodiments on the basis of the knowledge of a person skilled in the art, or to incorporate various modifications, such as design changes, into the embodiments. The embodiments incorporating such modifications can also be included in the scope of the present invention.

In the cores according to the embodiments, the thickness of the first component constituting the teeth and the thickness of the annular second component constituting the outer peripheral portion are substantially the same. By making the thickness of the second component greater than the thickness of the first component, the magnetic flux from the magnet may be able to be efficiently collected in the rotor, and the magnetic flux that contributes to the rotation of the motor may be increased.

The steel sheets used in the cores may all have the same thickness, or some of the steel sheets may have a different thickness. The electromagnetic steel sheets constituting the slotted layers may all have the same thickness, or some of the steel sheets may have a different thickness. The electromagnetic steel sheets constituting the slot-less layers may all have the same thickness, or some of the steel sheets may have a different thickness.

What is claimed is:

1. A rotor comprising:
a first component including a plurality of teeth radially disposed about a rotating axis;
a coil wound on the plurality of teeth; and
a tubular second component fixed to the first component so as to connect respective distal ends of the plurality of teeth, wherein:
the first component and the second component constitute a core, and
the second component has a multilayer structure of a plurality of laminated steel sheets.

2. The rotor according to claim 1, wherein:
each teeth includes a mating portion at a distal end, and
the second component includes a mated portion provided in a tubular inner peripheral portion thereof for fixing the mating portion.

3. The rotor according to claim 2, wherein the second component includes fixing portions provided at symmetric positions across the mating portion for fixing the laminated steel sheets together.

4. The rotor according to claim 1, wherein the second component includes a slot-less layer with a continuous circumference, and a slotted layer with a partly discontinuous circumference.

5. The rotor according to claim 2, wherein the second component includes a slot-less layer with a continuous circumference, and a slotted layer with a partly discontinuous circumference.

6. The rotor according to claim 3, wherein the second component includes a slot-less layer with a continuous circumference, and a slotted layer with a partly discontinuous circumference.

7. The rotor according to claim 4, wherein:
the slot-less layer includes a thin portion which is, in a direction of the rotating axis, adjacent to a slot formed in the slotted layer, and
the slot-less layer satisfies 0.2×t1<t2<5.0×t1 where t1 is the thickness of a single steel sheet, and t2 is the thickness in a radial direction of the thin portion.

8. The rotor according to claim 5, wherein:
the slot-less layer includes a thin portion which is, in a direction of the rotating axis, adjacent to a slot formed in the slotted layer, and
the slot-less layer satisfies 0.2×t1<t2<5.0×t1 where t1 is the thickness of a single steel sheet, and t2 is the thickness in a radial direction of the thin portion.

9. The rotor according to claim 6, wherein:
the slot-less layer includes a thin portion which is, in a direction of the rotating axis, adjacent to a slot formed in the slotted layer, and
the slot-less layer satisfies 0.2×t1<t2<5.0×t1 where t1 is the thickness of a single steel sheet, and t2 is the thickness in a radial direction of the thin portion.

10. The rotor according to claim 4, wherein 0<L<0.3×n3 where L is the height in a direction of the rotating axis of a slot formed in the slotted layer, and n3 is a total thickness of the core.

11. The rotor according to claim 5, wherein 0<L<0.3×n3 where L is the height in a direction of the rotating axis of a slot formed in the slotted layer, and n3 is a total thickness of the core.

12. The rotor according to claim 6, wherein 0<L<0.3×n3 where L is the height in a direction of the rotating axis of a slot formed in the slotted layer, and n3 is a total thickness of the core.

13. The rotor according to claim 7, wherein 0<L<0.3×n3 where L is the height in a direction of the rotating axis of a slot formed in the slotted layer, and n3 is a total thickness of the core.

14. The rotor according to claim 8, wherein 0<L<0.3×n3 where L is the height in a direction of the rotating axis of a slot formed in the slotted layer, and n3 is a total thickness of the core.

15. The rotor according to claim 9, wherein 0<L<0.3×n3 where L is the height in a direction of the rotating axis of a slot formed in the slotted layer, and n3 is a total thickness of the core.
